(19) United States
(12) Patent Application Publication
(10) Pub. No.: US 2015/0093073 A1
(43) Pub. Date: Apr. 2, 2015

(54) Optical Tap Modules Having Integrated Splitters And Aggregated Multi-Fiber Tap Output Connectors

(71) Applicant: Anue Systems, Inc., Austin, TX (US)

(72) Inventor: Cary J. Wright, Austin, TX (US)

(73) Assignee: Anue Systems, Inc., Austin, TX (US)

(21) Appl. No.: 14/041,354

(22) Filed: Sep. 30, 2013

(51) Int. Cl. G02B 6/28; G02B 6/38

(52) U.S. Cl. CPC G02B 6/2804; G02B 6/3893
USPC 385/24

(57) ABSTRACT

Embodiments are disclosed for tap modules having integrated splitters and aggregated multi-fiber tap output connectors. Tap modules are configured to receive optical input/output signals from optical input/output fibers connected to multiple network devices within a network communication system. The tap modules include splitters that are configured to generate multiple tap output signals that are proportional, lower-energy copies of optical signals being communicated between the network devices. These tap output signals are then provided to aggregated multi-fiber tap output connectors for the tap modules. These multi-fiber tap output connectors can then be utilized to connect to other network monitoring devices, such as network monitoring tool systems and/or network tool optimizing systems. The aggregated multi-fiber tap output connectors are configured to operate at a higher aggregated rate as compared to the optical input/output signals.

### TECHNICAL FIELD

The disclosed embodiments relate to optical communications for network systems.

### BACKGROUND

An optical splitter can be used to tap an optical signal. FIG. 1 (Prior Art) is an embodiment 100 for a prior solution that utilizes optical splitters to tap optical signals. A tap module 106 includes two splitters 108 and 110. Splitter 108 receives an optical input signal 124 from an optical input port 144, provides an optical output signal 126 to optical output port 142, and provides a lower energy version of the same optical output signal as optical output signal 128 to tap output port 148. Similarly, splitter 110 receives an optical input signal 120 from an optical input port 140, provides an optical output signal 122 to optical output port 146, and provides a lower energy version of the same optical output signal as optical output signal 130 to tap output port 150. Further, optical output fiber 112 and optical input fiber 114 for the first network device 102 are connected to optical input port 140 and optical output port 142 for tap module 106, respectively. Optical output fiber 116 and optical input fiber 118 for the second network device 104 are connected to optical input port 144 and optical output port 146 for tap module 106, respectively. Optical tap output fiber 132 provides a tap output signal for optical signals communicated from the first network device 102 to the second network device 104, and optical tap output fiber 134 provides a tap output signal for optical signals communicated from the second network device 104 to the first network device 102.

FIG. 2 (Prior Art) is an embodiment 200 for a connection panel for the tap module embodiment 100 of FIG. 1 (Prior Art). Region 202 includes the fiber input ports and output ports for optical fibers connected to network devices, and region 204 includes the tap output ports. In particular, optical input port 140 and optical output port 142 are used to connect input/output optical fibers to one network device, as shown with respect to embodiment 100 in FIG. 1 (Prior Art). Similarly, the optical input port 144 and optical output port 146 are used to connect input/output optical fibers to a second network device, as shown with respect to embodiment 100 in FIG. 1 (Prior Art). In addition, tap output port 148 and tap output port 150 are used to connect two optical fibers to external network devices. The optical ports 140, 142, 144, 146, 148, and 150 are individual optical fiber ports that are each configured to receive a single mode fiber optic cable. It is further noted that the optical ports 140/142, optical ports 144/146, and optical ports 148/150 can be implemented as port pairs configured to operate at a particular selected rate (e.g., 10 Gigabits per second).

### SUMMARY OF THE DISCLOSED EMBODIMENTS

Embodiments are disclosed for tap modules having integrated splitters and aggregated multi-fiber tap output connectors. Tap modules are configured to receive optical input/output signals from optical input/output fibers connected to multiple network devices within a network communication system. The tap modules include splitters that are configured to generate multiple tap output signals that are proportional, lower-energy copies of optical signals being communicated between the network devices. These tap output signals are then provided to aggregated multi-fiber tap output connectors for the tap modules. These multi-fiber tap output connectors can then be utilized to connect to network monitoring devices, such as network monitoring tool systems and/or network tool optimizing systems. The aggregated multi-fiber tap output connectors are configured to operate at a higher aggregated rate as compared to the optical input/output signals. Other features and variations can be implemented, if desired, and related systems and methods can be utilized, as well.

For one embodiment, an optical tap module for network communications is disclosed that includes at least four network input/output port pairs configured to operate at a first rate where each network input/output port pair is configured to receive at least one optical input fiber and at least one optical output fiber, a multi-fiber tap output connector having at least four tap output ports configured to receive at least four tap output optical fibers and configured to operate at a second rate, and a plurality of splitters configured to receive optical input signals from the network input ports and to split the optical input signals to generate optical output signals and tap optical output signals where the optical output signals are provided to the output ports and the tap optical output signals are provided to the tap ports.

In further embodiments, the multi-fiber tap output connector is configured to receive a multiple-fiber push-on (MPO) connector including at least four optical fiber pairs. In additional embodiments, only four of the optical fibers within the optical fiber pairs are configured to be used to carry tap optical output signals. Further, each network input/output port pair can be configured to receive an LC fiber connector. Still further, the multi-fiber tap output connector can be configured to receive a multiple-fiber push-on (MPO) connector including at least four optical fiber pairs. In addition, the second rate can be about four times or more greater than the first rate.

In another embodiment, a network tap system for network communications is disclosed that includes an optical tap module for network communications, at least four input/output fiber pairs coupled to network input/output port pairs, at least four network devices with each coupled to an input/output fiber pair, at least four tap output fibers coupled to the tap output ports, and at least one network monitoring device coupled to the tap output fibers. The optical tap module includes at least four network input/output port pairs configured to operate at a first rate where each network input/output port pair is configured to receive at least one optical input fiber and at least one optical output fiber, a multi-fiber tap output connector having at least four tap output ports configured to receive at least four tap output optical fibers and configured to operate at a second rate, and a plurality of splitters configured to receive optical input signals from the network input ports and to split the optical input signals to generate optical output signals and tap optical output signals where the optical output signals is provided to the network output ports and the tap optical output signals being provided to the tap output ports.

In further embodiments, the tap output fibers are connected to the optical tap module with an MPO (multi-fiber push-on) connector having at least four optical fiber pairs. In additional embodiments, only four of the optical fibers within the optical fiber pairs are configured to be used to carry tap optical output signals. Further, the input/output optical fibers can be connected to the optical tap module with LC fiber connectors. Still further, the multi-fiber tap output connector can be configured to receive a multiple-fiber push-on (MPO) connector including at least four optical fiber pairs. In addition, the second rate can be about four times or more greater than the first rate.

In still another embodiment, a method for tapping optical signals in network communications is disclosed that includes receiving a plurality of optical input signals through at least four input optical fibers connected to a plurality of network input/output port pairs, splitting the optical input signals into a plurality of optical output signals and a plurality of tap optical output signals, outputting the optical output signals to at least four output optical fibers connected to the plurality of network input/output port pairs, and outputting the tap optical output signals through a plurality of tap optical output ports within a multi-fiber tap output connector to at least four tap output optical fibers.

In further embodiments, the multi-fiber tap output connector can be configured to receive a multiple-fiber push-on (MPO) connector including at least four optical fiber pairs. In additional embodiments, only four of the optical fibers within the optical fiber pairs are configured to be used to carry tap optical output signals. Further, each input/output pair can be configured to receive an LC fiber connector. Still further, the multi-fiber tap output connector can be configured to receive a multiple-fiber push-on (MPO) connector including at least four optical fiber pairs. In addition, the second rate can be about four times or more greater than the first rate.

Other features and variations can be implemented, if desired, and related systems and methods can be utilized, as well.

### DESCRIPTION OF THE DRAWINGS

It is noted that the appended drawings illustrate only exemplary embodiments and are, therefore, not to be considered limiting of the scope of the invention, for the invention may admit to other equally effective embodiments.

FIG. 1 (Prior Art) is an embodiment for a prior solution that utilizes optical splitters to provide tap outputs for optical fibers.

FIG. 2 (Prior Art) is an embodiment for a connection panel for the tap module embodiment of FIG. 1 (Prior Art)

FIG. 3 is an embodiment for a tap module that utilizes a multi-fiber tap output connector to provide tapped optical signals for multiple network input/output port pairs.

FIG. 4 is an embodiment for a connection panel that could be utilized for the tap module embodiment of FIG. 3.

FIG. 5 is block diagram for a system embodiment including a tap module having a multi-fiber tap output connector.

FIG. 6 is a block diagram of an embodiment for the tap module in FIG. 5.

FIG. 7 is a flow diagram for providing multiple optical tap output signals using an aggregated multi-fiber tap output connector and optical splitters within network a tap module.

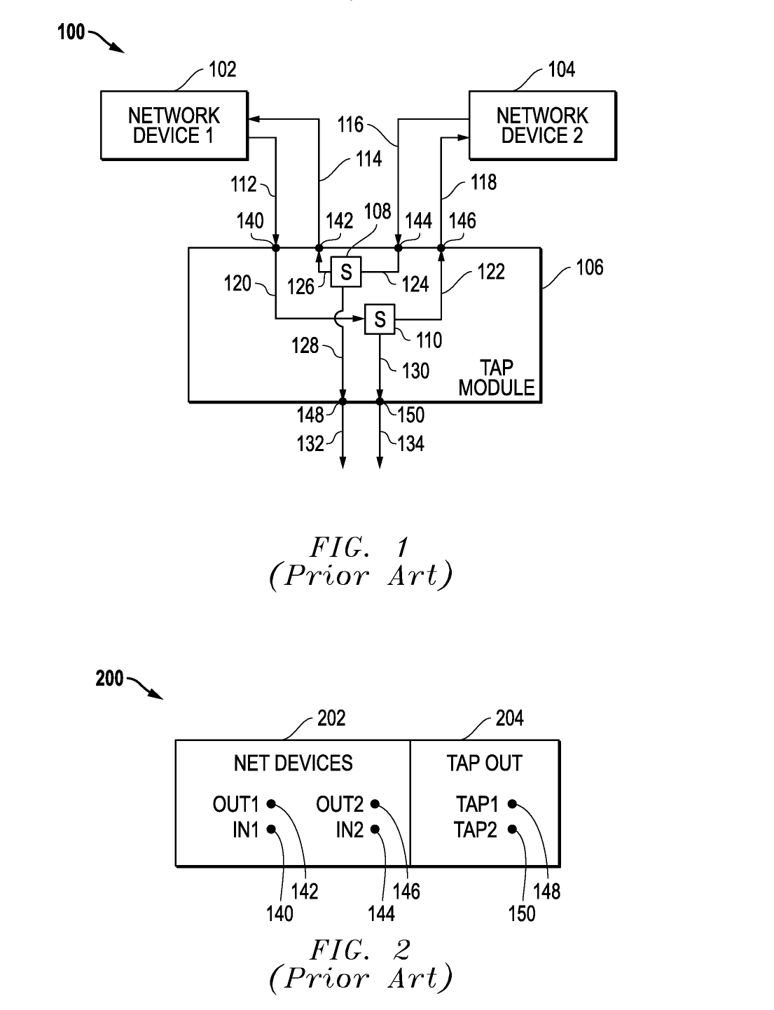

### DETAILED DESCRIPTION

Embodiments are disclosed for tap modules having integrated splitters and aggregated multi-fiber tap output connectors. Tap modules are configured to receive optical input/output signals from optical input/output fibers connected to multiple network devices within a network communication system. The tap modules include splitters that are configured to generate multiple tap output signals that are proportional, lower-energy copies of optical signals being communicated between the network devices. These tap output signals are then provided to aggregated multi-fiber tap output connectors for the tap modules. These multi-fiber tap output connectors can then be utilized to connect to other network monitoring devices, such as network monitoring tool systems and/or network tool optimizing systems. The aggregated multi-fiber tap output connectors are configured to operate at a higher aggregated rate as compared to the optical input/output signals. Other features and variations can be implemented, if desired, and related systems and methods can be utilized, as well.

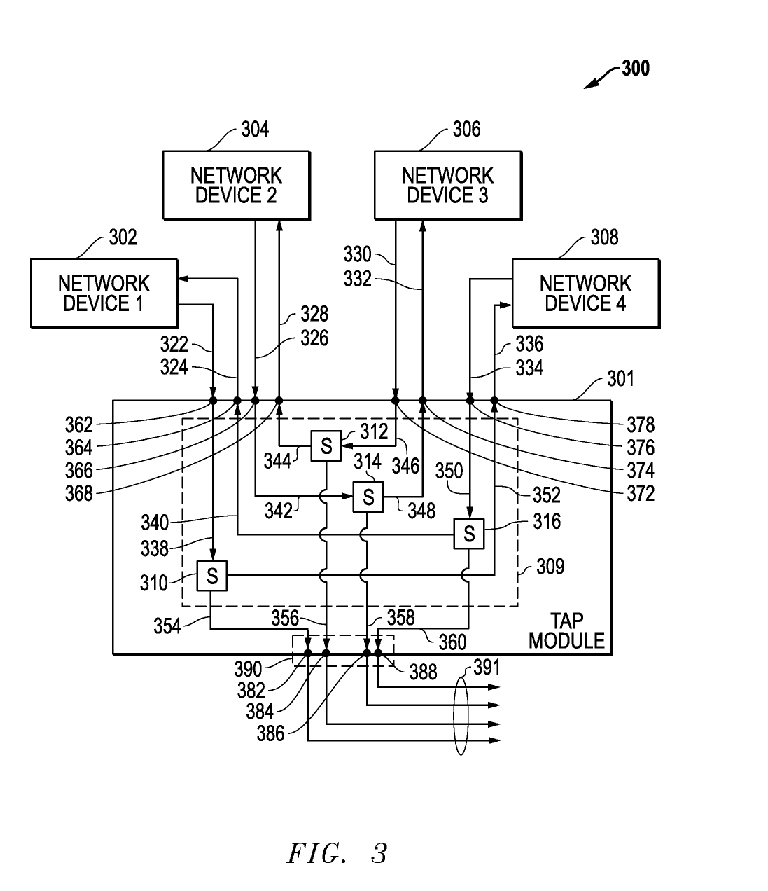

FIG. 3 is an embodiment 300 for a tap module 301 that utilizes splitters 309 and a multi-fiber tap output connector 390 to provide tapped optical output signals for multiple input/output fiber connections. For the embodiment depicted, the tap module 301 includes four splitters 310, 312, 314, and 316, although different numbers of splitters could also be utilized depending upon the number of communication desired to be monitored. Splitter 310 receives an optical input signal 338 from an optical input port 362, provides an optical output signal 352 to optical output port 372, and provides a lower energy version of the same optical output signal as optical output signal 354 to tap output port 382 within the multi-fiber tap output connector 390. Splitter 312 receives an optical input signal 346 from an optical input port 372, provides an optical output signal 344 to optical output port 368, and provides a lower energy version of the same optical output signal as optical output signal 356 to tap output port 384 within the multi-fiber tap output connector 390. Splitter 314 receives an optical input signal 342 from an optical input port 366, provides an optical output signal 348 to optical output port 374, and provides a lower energy version of the same optical output signal as optical output signal 358 to tap output port 386 within the multi-fiber tap output connector 390. Splitter 316 receives an optical input signal 350 from an optical input port 376, provides an optical output signal 340 to optical output port 364, and provides a lower energy version of the same optical output signal as optical output signal 360 to tap output port 388 within the multi-fiber tap output connector 390.

For the embodiment 300 depicted, the communications between a first network device 302 and a fourth network device 308 are being monitored, as well as the communications between a second network device 304 and a third network device 306. Optical output fiber 322 and optical input fiber 324 for the first network device 302 are connected to optical input port 362 and optical output port 364 for tap module 301, respectively. Optical output fiber 326 and optical input fiber 328 for the second network device 304 are connected to optical input port 366 and optical output port 368 for tap module 301, respectively. Optical output fiber 330 and optical input fiber 332 for the third network device 306 are connected to optical input port 372 and optical output port 374 for tap module 301, respectively. Optical output fiber 334 and optical input fiber 336 for the fourth network device 308 are connected to optical input port 376 and optical output port 378 for tap module 301, respectively. The optical output fibers and optical input fibers are configured to operate at a designated rate (e.g., 10 Gigabits per second).

The multi-fiber tap output connector 390, which includes tap output ports 382/384/386/388, provides tapped copies of the optical signals communicated from the first network device 302 to the fourth network device 308, communicated from the fourth network device 308 to the first network device 302, communicated from the second network device 304 to the third network device 306, and communicated from the third network device 306 to the second network device 304. Advantageously, the multi-fiber tap output connector 390 provides a tap interface that includes multiple fiber connection ports for multiple output fibers 391 within a single connector housing. Further, the multi-fiber tap output connector 390 aggregates the optical signals and is configured to operate at a higher aggregated rate (e.g., 40 Gigabits per second or more) that is about four times or more greater than the rate for the input/output optical ports (e.g., 10 Gigabits per second or less). Further, it is noted that if rates over 10 Gigabits per second are used for the optical input/output ports, the aggregated rate would still be configured to be about four times or more greater than the input/output ports.

As one example, the multi-fiber tap output connector 390 can include a housing and optical ports configured to receive a multiple-fiber push-on (MPO) connector that is configured to terminate the multiple optical tap fibers 391. As a further example, if four splitters and associated tap outputs are provided by the tap module 301, the multi-fiber tap output connector 390 can include four fiber ports configured to receive an MPO connector terminating four parallel (e.g., quad-fiber) optical fibers. By using a multi-fiber tap output connector 390, as described herein, simplified optical connections can be provided within a single housing, thereby greatly simplifying installation, and reducing complexity for network connections. In addition, using MPO connectors also allows for flat ribbon-type cables to be utilized, thereby reducing space required for fiber connections and the connection panel. Other variations could also be implemented.

FIG. 4 is an embodiment 400 for a connection panel that could be utilized for the tap module 301 of FIG. 3. Region 402 includes fiber connection ports for the network devices with respect to which communications are being monitored, and region 404 includes the tap output ports. In particular, optical input ports 362/366/372/376 and optical output ports 364/368/374/378 for the four network devices 302/304/306/308 are shown in region 402. The multi-fiber tap output connector 390 includes tap output fiber ports 382/384/386/388 within a single connector housing. As described above, the connector 390 can be configured to receive a multi-fiber MPO connector and can be configured operate at an aggregated rate. It is further noted that the input/output ports can be configured as input/output port pairs that receive dual fiber connectors configured to operate at a lower rate, such that the aggregated rate is about four times or more higher than this lower rate. Further, with respect to the input/output ports, a connector 406 can include input/output ports 362/364 and can be configured to receive a dual fiber connector, such as a single dual-fiber cable terminated with an LC fiber connector. Similarly, connectors 408, 410, and 412 can include input/output ports 366/368, 372/374, and 376/378, respectively, and each of the connectors 408/410/412 can be configured to receive a dual fiber connector, such as a single dual-fiber cable terminated with an LC fiber connector.

The optical fiber input/output ports and tap output ports can be configured to interface with a variety of types of optical fibers. For example, the optical input/output fibers to the network devices 302/304/306/308 can be configured as multi-mode parallel fibers, such that each pair of fibers 322/324, 326/328, 330/332, and 334/336 are implemented as a single dual-fiber cable. Further, the connections to the network devices 302/304/306/308 can be implemented using LC connectors. As a further example, the tap output fibers 391 can be implemented using four multi-mode dual-fiber cables, even though only one fiber within each dual-fiber cable would be utilized to provide the tap output fibers 391, where four tap outputs are used. For such an embodiment, the tap output fibers 391 can be terminated using an MPO connector that can be connected to a QSFP (quad small form-factor pluggable) module within an external network system, such as a network monitoring tool or network tool optimizer.

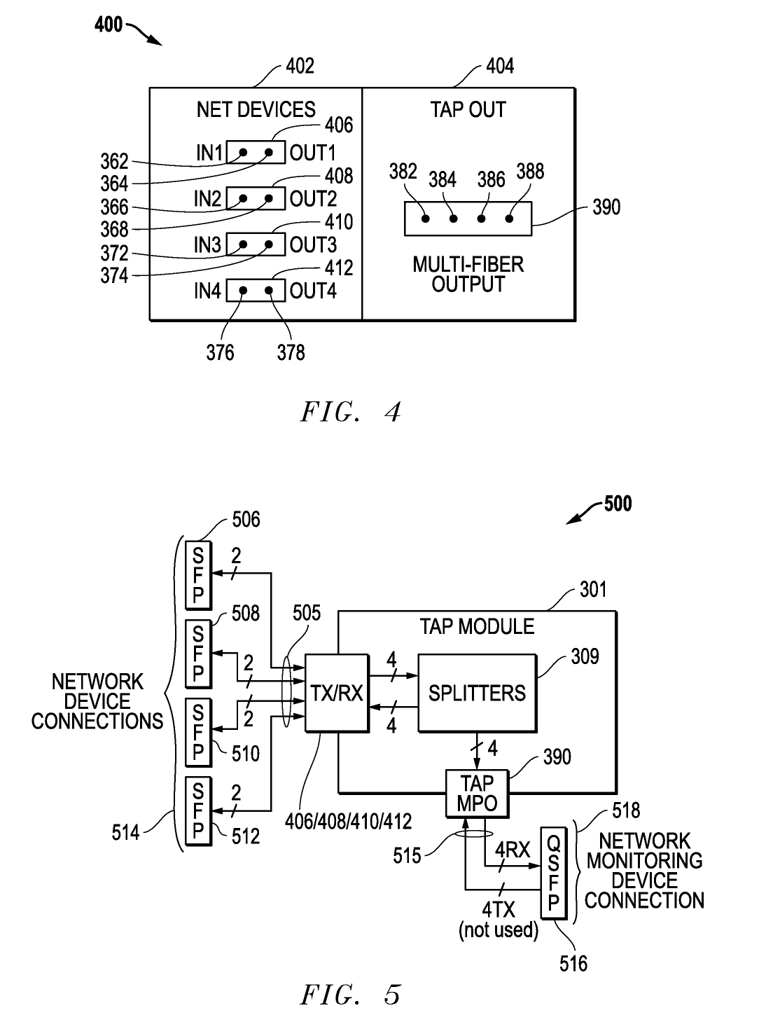

FIG. 5 is block diagram for a system embodiment 500 including a tap module 301 and optical fibers connected to SFP (smal form-factor pluggable) modules and QSFP modules using LC connectors and MPO connectors, respectively. The tap module 301 has transmit (TX) and receive (RX) port pair connectors 406/408/410/412 that are each configured to receive an LC fiber connector that terminates a single multi-mode dual-fiber cable. At the other end, these four multi-mode dual-fiber cables 505 can be terminated with LC fiber connectors that connect to SFP modules 506/508/510/512 within network devices in order to make network device connections 514. The tap module 301 also includes a multi-fiber tap connector 390 configured to receive an MPO connector that terminates four multi-mode dual-fiber cables. At the other end, these four multi-mode dual-fiber cables 515 can be terminated with an MPO connector that connects to a QSFP module 516 within a network monitoring device in order to make a network monitoring device connection 518. As described herein, the network monitoring device can be a network monitoring tool, a network tool optimizer, and/or any other desired network monitoring system. It is noted that other optical connector formats could also be utilized for connections to the tap module 301, to the network devices, and/or to the network monitoring devices.

Internally within the tap module 301, splitters 309 receive the inputs/output signals from the network devices and provide four tapped optical signals to the multi-fiber tap output connector 390, which in turn feeds the four optical fibers 515 that are connected to the QSFP module 516. It is noted that QSFP modules typically include four receive (RX) fibers and four transmit (TX) fibers configured as four RX/TX fiber pairs. As with embodiment 300 in FIG. 3, four splitters can be included within splitters 309. With respect to tap MPO connector 390, therefore, the four transmit (TX) fibers would not be used.

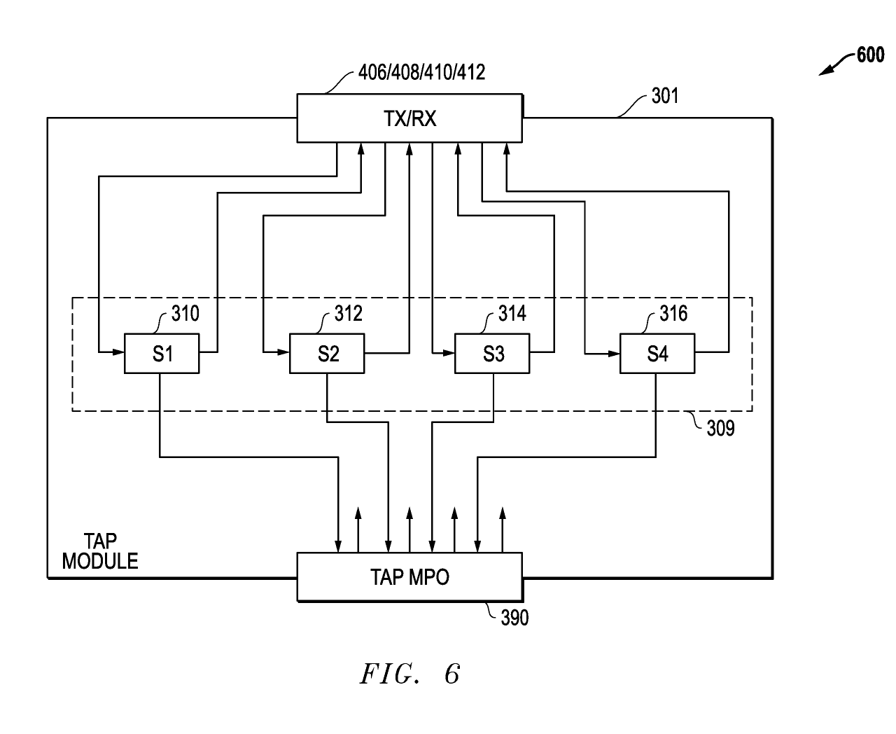

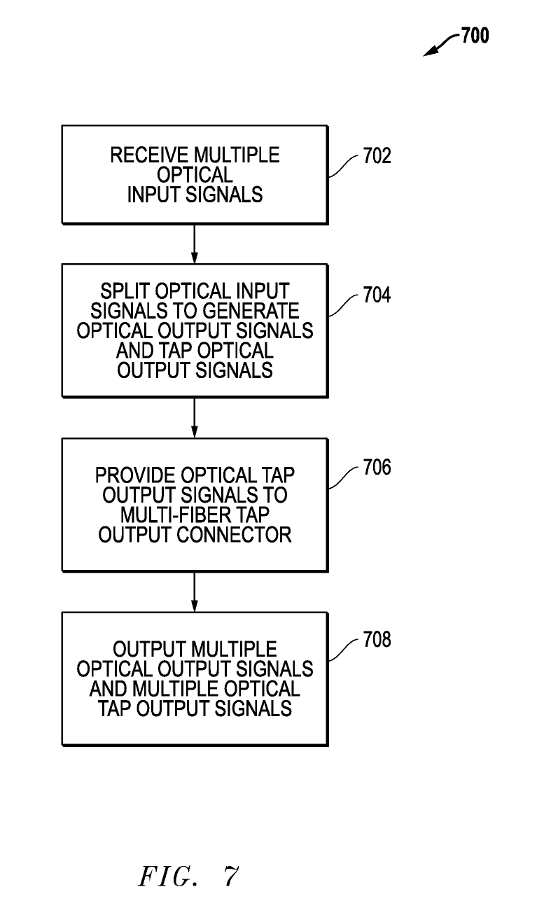

FIG. 6 is a block diagram of an embodiment 600 for the tap module 301 in FIG. 5. Four pairs of receive (RX) and transmit (TX) optical signals are provided through the input/output connectors 406/408/410/412. One of the optical input signals from the connectors 406/408/410/412 is provided to each of the optical splitters 310/312/314/316, and the optical output signals from the optical splitters 310/312/314/316 are provided back to the connectors 406/408/410/412. The optical tap output signals from the splitters 310/312/314/316 are provided to the tap MPO connector 390. As described above, where dual-fiber RX/TX cables are connected to the tap MPO connector 390, four of the fibers will not be utilized with respect to the tap MPO connector 390. This is shown in embodiment 600 by the four unconnected arrows extending from tap MPO connector 390. Further, as described herein, the aggregated multi-fiber tap output connector 390 is configured to operate at a higher aggregated rate (e.g., 40 Gigabits per second or more) that is about four times or more greater than the optical input/output connectors (e.g., 10 Gigabits per second or less). It is again noted that if rates over 10 Gigabits per second are used for the optical input/output connectors, the aggregated rate would still be configured to be about four times or more greater than the input/output connectors.

It is noted that other optical fiber connectors and related transceiver modules can also be utilized with respect to the disclosed embodiments in addition to and/or instead of the SFP modules, QSFP modules, LC connectors, and MPO connectors described herein. For example, in addition to SFP/QSFP modules and LC/MPO connectors, other optical connectors and transceiver modules can be utilized, such as GBIC (Gigabit Interface Converter) transceiver modules, SFP+ (Enhanced Small-Form-factor Pluggable) transceiver modules, XFP (10 Gbps Small Form-factor Pluggable) transceiver modules, CXP (120 Gbps 12× Small Form-factor Pluggable) transceiver modules, CFP (C Form-factor Pluggable) transceiver modules, and/or other desired optical connectors, transceiver modules, or combinations thereof.

It is further noted that an optical transceiver module is typically an integrated pluggable module that takes electrical signals from local electronics and converts them to an optical form for longer distance transmission and/or that converts long distance optical transmissions back to an electrical signal that can be received by local electronics. Long haul signals are typically optical. However, they can also be electrical signals transmitted, for example, on CAT 5 cables, CAT6 cables, or some specialized low-loss transmission cable.

SFP and SFP+ modules are optical transceiver modules configured for 1 Gigabit-per-second and 10 Gigabit-per-second communications, respectively. SFP/SFP+ transceiver modules have standardized electrical interfaces and mechanical dimensions. The network side interface for SFP/SFP+ transceiver modules can be optical or electrical. One common network side interface for SFP/SFP+ transceiver modules is a pair of LC fiber connectors that terminate two optical fibers that are either single mode or multi-mode fibers. It is also possible to terminate the network side interface with an RJ45 electrical interface for CAT5 or CAT6 cabling. Further, a single fiber can be used for PON (Passive Optical Network) connections where transmit (TX) and receive (RX) are on the same fiber. For the embodiment described herein, it is assumed that LC fiber pair connections are used to connect to the SFP modules, although other connectors could also be utilized.

QSFP is another optical transceiver module form factor. Similar to SFP/SFP+ transceiver modules, QSFP transceiver modules have standardized electrical interfaces and mechanical dimensions. The network side interface can be an MPO connector (e.g., 4 transmit fibers and 4 receiver fibers). The network side interface can also be a single LC fiber pair connector for 40 Gigabit-per-second communications over a single fiber using WDM (Wavelength-Division Multiplexing).

Fiber optic connectors are also used to connect one optical fiber or transmission medium to another. MPO connectors are fiber optic connectors that come in multiple standard sizes having at least 8 fibers (e.g., 4 transmit and 4 receive) for 40 Gigabit Ethernet (GbE) and 12 or 24 fibers for 100 GbE. Advantages of MPO connectors include their very compact size and their ability to allow for connections to very compact QSFP or CXP transceiver modules. As described above, where an MPO connector is used for the multi-fiber tap output connector to provide four tap outputs, four fibers can be installed out of the eight positions typically available in MPO connectors. LC connectors are compact single fiber connectors. LC connectors are usually grouped together in TX/RX pairs with clips, and LC connectors are the most common connector format for SFP/SFP+/XFP transceiver modules. For FIG. 5 above, one cable that could be utilized to make the network monitoring device connection 514 is a breakout cable that includes one MPO connector at one end (e.g., connecting to the connector 390) breaking out to four pairs of LC connectors at the other end (e.g., connecting to network monitoring device equipment having SFP/SFP+ transceiver modules). Other optical connector formats could also be utilized.

FIG. 7 is a flow diagram for generating multiple optical tap output signals using an aggregated multi-fiber tap output connector and optical splitters within a network tap module. In block 702, multiple optical input signals are received, for example, through multiple input optical fibers connected to network devices. In block 704, the optical input signals are split to generate optical output signals and tap optical output signals. As described herein, a plurality of splitters can be used to split the optical input signals. In block 706, the optical tap output signals are provided to an aggregated multi-fiber tap output connector. As described above, this multi-fiber output connector includes multiple fiber ports within a single housing and can be configured to receive MPO connectors, if desired. Finally, in block 708 the multiple optical output signals and the multiple optical tap output signals are output by the tap module.

Further modifications and alternative embodiments will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the example embodiments. Various changes may be made in the implementations and architectures described herein. For example, equivalent elements may be substituted for those illustrated and described herein, and certain features of the embodiments may be utilized independently of the use of other features, as would be apparent to one skilled in the art after having the benefit of this description.

What is claimed is:

1. An optical tap module for network communications, comprising:
at least four network input/output port pairs configured to operate at a first rate, each network input/output port pair being configured to receive at least one optical input fiber and at least one optical output fiber;
a multi-fiber tap output connector having at least four tap output ports configured to receive at least four tap output optical fibers and configured to operate at a second rate; and
a plurality of splitters configured to receive optical input signals from the network input ports and to split the optical input signals to generate optical output signals and tap optical output signals, the optical output signals being provided to the network output ports and the tap optical output signals being provided to the tap output ports.

2. The optical tap module of claim 1, wherein the multi-fiber tap output connector is configured to receive a multiple-fiber push-on (MPO) connector including at least four optical fiber pairs.

3. The optical tap module of claim 2, wherein only four of the optical fibers within the optical fiber pairs are configured to be used to carry tap optical output signals.

4. The optical tap module of claim 1, wherein each network input/output port pair is configured to receive an LC fiber connector.

5. The optical tap module of claim 4, wherein the multi-fiber tap output connector is configured to receive a multiple-fiber push-on (MPO) connector including at least four optical fiber pairs.

6. The optical tap module of claim 1, wherein the plurality of splitters comprises four splitters.

7. The optical tap module of claim 1, wherein the second rate is about four times or more greater than the first rate.

8. A network tap system for network communications, comprising:
an optical tap module for network communications, comprising:
at least four network input/output port pairs configured to operate at a first rate, each network input/output port pair being configured to receive at least one optical input fiber and at least one optical output fiber;
a multi-fiber tap output connector having at least four tap output ports configured to receive at least four tap output optical fibers and configured to operate at a second rate; and
a plurality of splitters configured to receive optical input signals from the network input ports and to split the optical input signals to generate optical output signals and tap optical output signals, the optical output signals being provided to the network output ports and the tap optical output signals being provided to the tap output ports;
at least four input/output fiber pairs coupled to the network input/output port pairs;
at least four network devices, each coupled to an input/output fiber pair;
at least four tap output fibers coupled to the tap output ports; and
at least one network monitoring device coupled to the tap output fibers.

9. The network tap system of claim 8, wherein the tap output fibers are connected to the optical tap module with an MPO (multi-fiber push-on) connector having at least four optical fiber pairs.

10. The network tap system of claim 9, wherein only four of the optical fibers within the optical fiber pairs are configured to be used to carry tap optical output signals.

11. The network tap system of claim 8, wherein the input/output optical fibers are connected to the optical tap module with LC fiber connectors.

12. The network tap system of claim 11, wherein the multi-fiber tap output connector is configured to receive a multiple-fiber push-on (MPO) connector including at least four optical fiber pairs.

13. The network tap system of claim 8, wherein the second rate is about four times or more greater than the first rate.

14. A method for tapping optical signals in network communications, comprising:
receiving a plurality of optical input signals through at least four input optical fibers connected to a plurality of network input/output port pairs;
splitting the optical input signals into a plurality of optical output signals and a plurality of tap optical output signals;
outputting the optical output signals to at least four output optical fibers connected to the plurality of network input/output port pairs; and
outputting the tap optical output signals through a plurality of tap optical output ports within a multi-fiber tap output connector to at least four tap output optical fibers.

15. The method of claim 14, wherein the multi-fiber tap output connector is configured to receive a multiple-fiber push-on (MPO) connector including at least four optical fiber pairs.

16. The method of claim 15, wherein only four of the optical fibers within the optical fiber pairs are configured to be used to carry tap optical output signals.

17. The method of claim 14, wherein each input/output pair is configured to receive an LC fiber connector.

18. The method of claim 17, wherein the multi-fiber tap output connector is configured to receive a multiple-fiber push-on (MPO) connector including at least four optical fiber pairs.

19. The method of claim 14, wherein the second rate is about four times or more greater than the first rate.

20. The method of claim 14, further comprising receiving the tap optical output signals with a network monitoring device.
